(19) United States
(12) Patent Application Publication
(10) Pub. No.: US 2026/0171889 A1
(43) Pub. Date: Jun. 18, 2026

(54) STEP-DOWN SOCKET INTEGRATED WITH A PURE SINE WAVE VOLTAGE CONVERSION FUNCTION

(71) Applicant: Dongguan Fukun Electrical Appliance Co., Ltd., Dongguan City (CN)

(72) Inventor: Zhaokun Zeng, Dongguan City (CN)

(21) Appl. No.: 19/021,199

(22) Filed: Jan. 15, 2025

(30) Foreign Application Priority Data
Dec. 17, 2024 (CN) 2024118612330

(51) Int. Cl. H02M 1/00; H02M 1/44; H02M 5/46

(52) U.S. Cl. CPC H02M 1/0048; H02M 1/44; H02M 5/46

(57) ABSTRACT

A step-down socket integrated with a pure sine wave voltage conversion function, comprising: an AC input module, a main control unit, an inverter bridge module, and a voltage-current feedback module, wherein the AC input module is receive AC mains power and introduce the AC mains power into a rectification and filtering module, which rectifies and filters the AC mains power into DC; the main control unit, by generating a sine wave pulse-width modulation (SPWM) signal, controls the switching and duty cycle of the inverter bridge module, such that the inverter bridge module converts the DC from the rectification and filtering module into a pulsed voltage and outputs the pulsed voltage to an energy storage and filtering module; the inverter bridge module comprises multiple MOSFETs; the energy storage and filtering module filters the pulsed voltage into a pure sine wave AC voltage, which is then output through an AC terminal.

### FIELD OF THE INVENTION

The present invention relates to the technical field of socket converters, specifically to a step-down pure sine wave voltage conversion outlet.

### BACKGROUND OF THE INVENTION

With the development of globalization and the popularization of international travel, more and more people are crossing borders for business trips, tourism, or work. However, the sockets and voltage standards used worldwide vary, causing inconvenience when using electronic devices. Common voltages on the market are usually 110V or 220V. When electronic devices are used across countries, if the plug is incompatible or the voltage does not match, it not only prevents the device from charging or operating normally but may also cause damage to the equipment or lead to safety accidents.

To solve the above problems, there are currently AC TO AC step-down travel power strips that produce a square wave (also known as a modified sine wave), but many devices cannot run on a square wave. There are also AC TO AC step-down travel power strips that output pure sine waves; however, such voltage conversion outlets usually first rectify and filter the mains power into DC, then use a DC TO DC step-down circuit to reduce the voltage, and finally use an inverter bridge circuit to convert it into a pure sine wave output. Moreover, many of these devices only provide 50 Hz output, have complex circuits, high costs, and low efficiency.

In view of this, the inventors of the present invention propose the following technical solution.

### SUMMARY OF THE INVENTION

The purpose of the present invention is to overcome the shortcomings of the existing technology by providing a step-down pure sine wave voltage conversion outlet. In this invention, the DC TO DC step-down circuit after rectification and filtering is removed, and through adjusting the duty cycle, the inverter bridge module directly steps down and inverts the power into a sine wave output.

To solve the above technical problems, the present invention adopts the following technical solution: A step-down pure sine wave voltage conversion outlet, including: an AC input module, used to receive and introduce AC mains power to the rectification and filtering module, and to rectify and filter the AC mains power into DC; a main control unit, an inverter bridge module, and a voltage and current feedback module. The main control unit generates a sine wave pulse width modulation (SPWM) signal, controlling the switching and duty cycle of the inverter bridge module so that the inverter bridge module converts the DC power from the rectification and filtering module into a pulsed voltage and outputs it to the energy storage and filtering module; the inverter bridge module includes multiple MOSFETs, having its input end connected to the rectification and filtering module, and its output end connected to the energy storage and filtering module. The energy storage and filtering module's input end is connected to the inverter bridge module to filter the pulsed voltage into a pure sine wave AC voltage, and to output it through the AC terminal; the voltage and current feedback module is connected to the output end of the energy storage and filtering module, used for detecting the output voltage and current, and transmitting the feedback signal to the main control unit, which adjusts the SPWM signal according to the feedback voltage and current signals to stabilize the output sine wave voltage.

Furthermore, in the above technical solution, the inverter bridge module includes MOSFET M1, MOSFET M2, MOSFET M3, and MOSFET M4. The G (gate) of each MOSFET is connected to the driver chip in the main control unit through peripheral driver units. When the main control chip of the main control unit outputs the sine wave pulse width modulation (SPWM) signal, it drives the four MOSFETs to operate, generating a sine wave pulse width modulation pulsed voltage waveform, which is then filtered by the connected energy storage and filtering module to form a pure sine wave AC voltage output.

Furthermore, in the above technical solution, the energy storage and filtering module includes inductor L1 and capacitor C12, connected between the inverter bridge module and the AC terminal. It filters the sine wave pulse width modulation pulsed voltage generated by the inverter bridge module into a pure sine wave AC voltage output.

Furthermore, in the above technical solution, a DC power supply circuit is also included. The DC power supply circuit includes DC12V and DC5V. DC12V is used to power the driver chip in the main control unit, and DC5V is used to power the main control chip in the main control unit.

Furthermore, in the above technical solution, an NTC temperature detection circuit is provided to detect the temperature on heating components, providing a basis for over-temperature protection of the components.

Furthermore, in the above technical solution, a touch module is also included. This touch module controls the main control unit's ON and OFF states by outputting high and low levels. When the device is in the OFF state, touching the touch switch once causes the touch IC to output a high level to the main control unit, which then generates the sine wave pulse width modulation (SPWM) signal to drive the inverter bridge circuit, producing an AC voltage output at the AC outlet; touching the touch switch again causes the touch IC to output a low level to the main control unit, which stops the sine wave pulse width modulation (SPWM) signal, and the inverter bridge circuit stops operating, leaving the AC outlet with no voltage output.

Furthermore, in the above technical solution, a USB charging module is also included.

By adopting the above technical solution, compared with the existing technology, the present invention achieves the following beneficial effects: In the present invention, by reducing the front-end DC TO DC step-down circuit and using the inverter bridge module to directly step down from DC to AC through adjusting the duty cycle of the SPWM sine wave signal, the number of components is reduced, cost is lowered, and efficiency is improved.

### BRIEF DESCRIPTION OF THE DRAWINGS

FIG. 1 is the circuit diagram of the switching bridge circuit in the present invention;

FIG. 2 is the circuit diagram of the main control unit in the present invention;

FIG. 3 is the circuit diagram of the USB charging module in the present invention;

FIG. 4 is the circuit diagram of the DC power supply circuit in the present invention;

FIG. 5 is the circuit diagram of the output voltage detection module in the present invention;

FIG. 6 is the circuit diagram of the output temperature detection module in the present invention.

### DETAILED DESCRIPTION OF THE EMBODIMENTS

The present invention is further described below in conjunction with specific embodiments and accompanying figures.

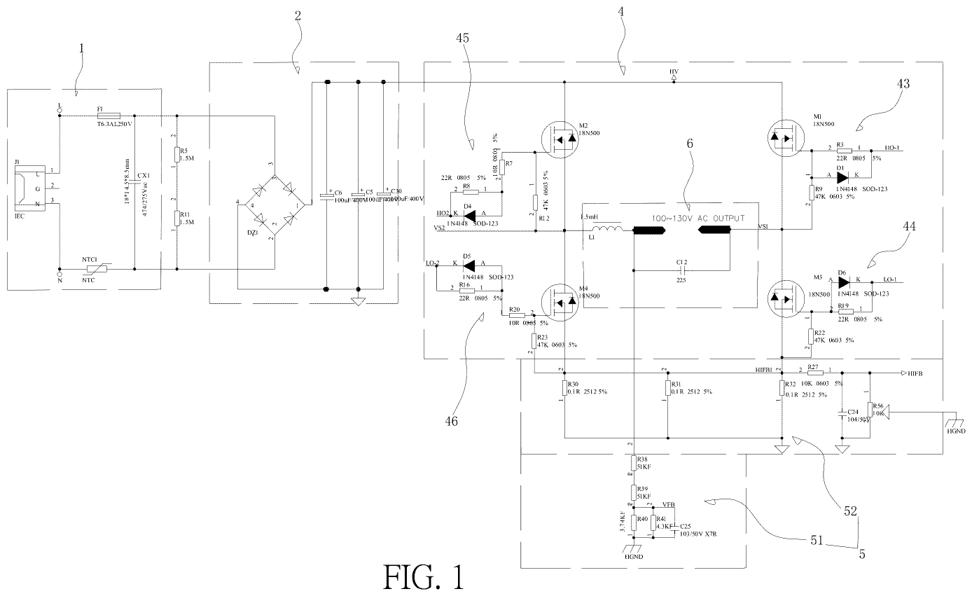

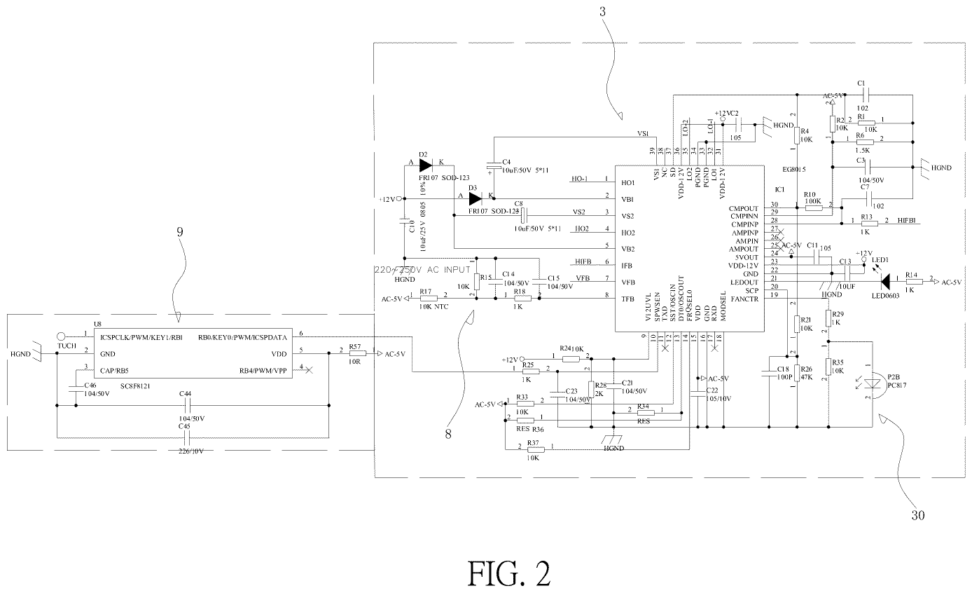

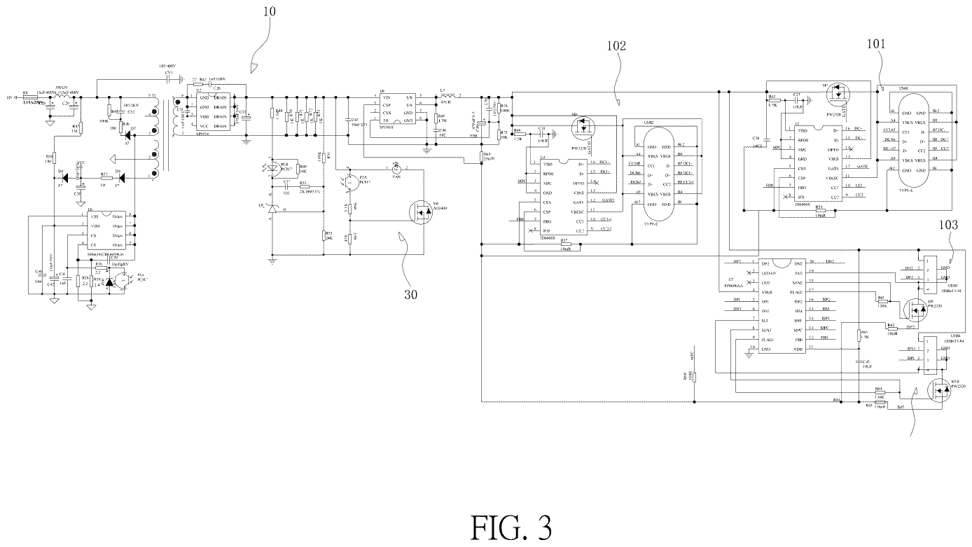

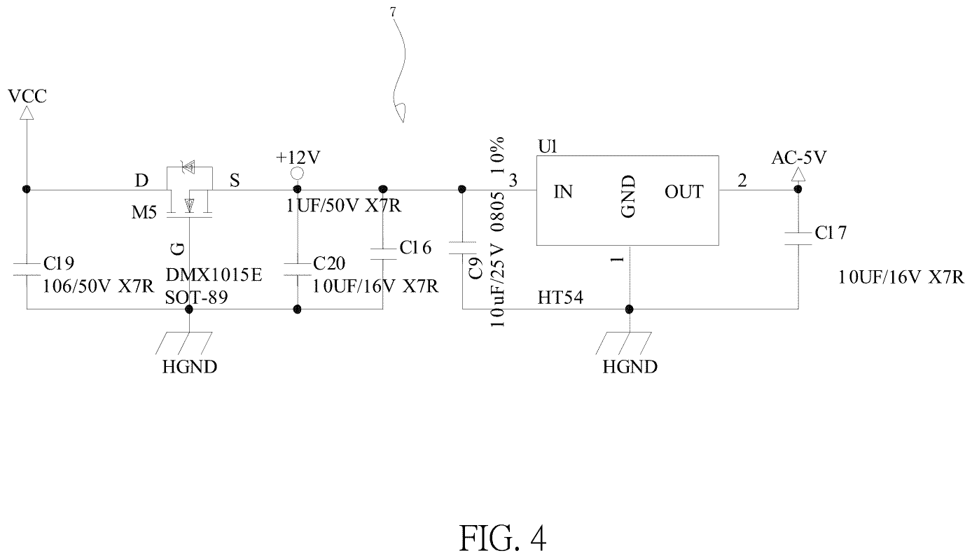

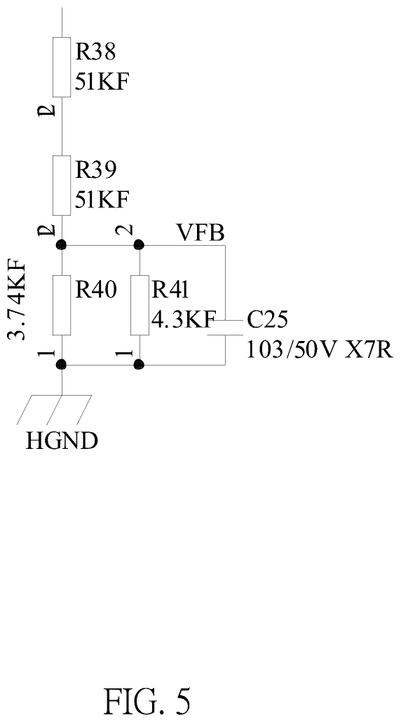

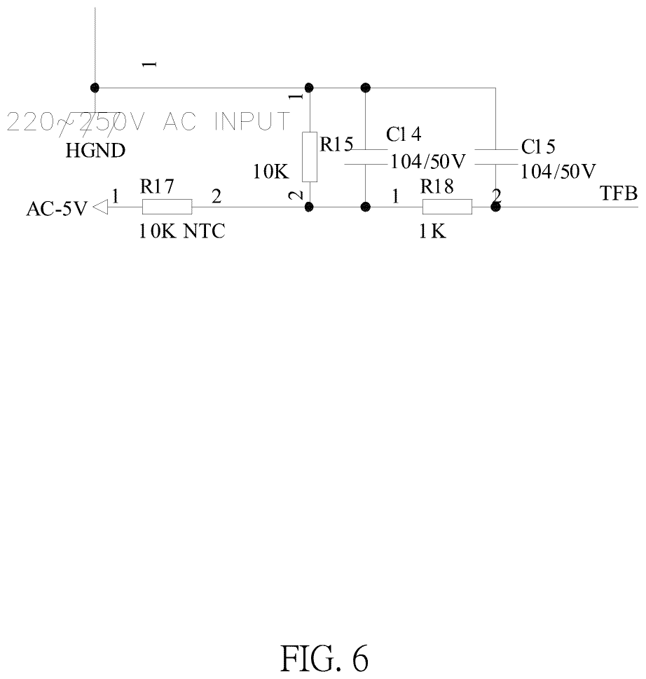

As shown in FIGS. 1 to 6, this step-down pure sine wave voltage conversion outlet includes: AC input module 1, main control unit 3, inverter bridge module 4, and voltage and current feedback module 5. Among these:
AC input module 1 is used to receive and introduce AC mains power to rectification and filtering module 2, which rectifies and filters AC mains power into DC. The main control unit 3 generates a sine wave pulse width modulation (SPWM) signal to control the switching and duty cycle of inverter bridge module 4, causing the inverter bridge module 4 to convert the DC from rectification and filtering module 2 into a pulsed voltage and output it to energy storage and filtering module 6. Inverter bridge module 4 includes multiple MOSFETs, whose input ends are connected to rectification and filtering module 2, and whose output ends are connected to energy storage and filtering module 6. The energy storage and filtering module 6, with its input end connected to the inverter bridge module 4, filters the pulsed voltage into a pure sine wave AC voltage and outputs it through the AC terminal. Voltage and current feedback module 5 is connected to the output end of the energy storage and filtering module 6 to detect the output voltage and current, and transmits feedback signals to the main control unit 3. According to the feedback voltage and current signals, the main control unit 3 adjusts the SPWM signal to stabilize the output sine wave voltage.

Using rectification and filtering module 2 to convert the AC input into DC for the inverter bridge module 4, composed of MOSFET M1, MOSFET M2, MOSFET M3, and MOSFET M4, this module converts DC into an AC output. MOSFETs M2, M3, and M4 form one group of switches. When MOSFETs M2 and M3 operate, M1 does not. The main control unit 3 sends the 20 kHz SPWM with adjusted pulse width to drive MOSFET M2, switching MOSFET M2 on and off. When MOSFET M2 is off, MOSFET M4 turns on to provide a freewheeling path for inductor L1, and MOSFET M3 remains continuously on. The duty cycle of the SPWM switches from small to large to reach the sine wave peak, then from large to small. This sends the HV high-voltage DC from MOSFET M2 into the energy storage and filtering network composed of inductor L1 and capacitor C12, which converts the switching pulses from MOSFET M2 into the positive half-cycle of the sine wave.

At the same time, MOSFETs M1, M4, and M2 form a group of switches that generates the negative half-cycle of the sine wave. The main control unit 3 sends the 20 kHz SPWM waveform to drive MOSFET M4. MOSFET M3 is not operating, and when MOSFET M4 is off, MOSFET M2 turns on to provide a freewheeling path for inductor L1, while MOSFET M1 remains continuously on. The duty cycle of the SPWM again goes from small to large until it reaches the top of the sine wave, then from large to small. This sends the HV high-voltage DC from MOSFET M1 to the energy storage and filtering network formed by inductor L1 and capacitor C12, which converts the switching pulses from MOSFET M1 into the negative half-cycle of the sine wave. During this process, the network composed of inductor L1 and capacitor C12 filters the SPWM pulses from the switching MOSFETs into a sine wave.

In one embodiment, in the step-down pure sine wave voltage conversion outlet, the inverter bridge module 4 includes MOSFET M1, MOSFET M2, MOSFET M3, and MOSFET M4. The G (gate) of each MOSFET is connected to the driver chip in main control unit 3 through peripheral driver units. When the main control chip of the main control unit 3 sends out the sine wave pulse width modulation (SPWM) signal, it drives the four MOSFETs to operate, generating a sine wave pulse width modulation voltage waveform, which, after filtering by the energy storage and filtering module 6, becomes a pure sine wave AC voltage output. The driver unit includes a first driver module 43 connected between MOSFET M1 and the switching bridge control circuit 5, a second driver module 44 connected between MOSFET M2 and the switching bridge control circuit 5, a third driver module 45 connected between MOSFET M3 and the switching bridge control circuit 5, and a fourth driver module 46 connected between MOSFET M4 and the switching bridge control circuit 5.

The first driver module 43 includes resistor R3, diode D1, and resistor R9 in parallel on the gate of MOSFET M1. Resistor R3 and diode D1 are connected at their other ends to the H0-1 pin in main control unit 3. Resistor R9 is connected to the source pin(S) of MOSFET M1, which connects to the N-OUT pin of energy storage and filtering module 6 and the drain pin (D) of MOSFET M3. The drain pin (D) of MOSFET M1 is connected to rectification and filtering module 2. The structure of the third driver module 45 is the same as that of the first driver module 43, and the third driver module 45 is connected to the L0-1 pin in main control unit 3.

The second driver module 44 includes resistors R7 and R8 in series between the gate (G) of MOSFET M2 and the H0-2 pin in main control unit 3, diode D4 in parallel with resistor R8, and resistor R12 between the gate (G) of MOSFET M2 and the VS2 pin in main control unit 3. The drain pin (D) of MOSFET M2 is connected to rectification and filtering module 2. The source pin (S) of MOSFET M2 is connected to the VS2 pin in main control unit 3 and to inductor L1 in the energy storage and filtering module 6, as well as to the drain pin (D) of MOSFET M4. The fourth driver module 46 has the same structure as the second driver module 44 and is connected to the L0-1 pin in main control unit 3.

In one embodiment, the energy storage and filtering module 6 includes inductor L1 and capacitor C12. It is connected to inverter bridge module 4 and the AC terminal, filtering the sine wave pulse width modulation pulsed voltage from inverter bridge module 4 into a pure sine wave AC voltage output. The AC terminal includes an N-OUT pin connected to MOSFETs M1 and M3, and an L-OUT pin connected to MOSFETs M2 and M4. Inductor L1 in energy storage and filtering module 6 is placed between the L-OUT pin and MOSFETs M2, M4. Capacitor C12 in energy storage and filtering module 6 is connected between the L-OUT pin and the N-OUT pin.

In one embodiment, the step-down pure sine wave voltage conversion outlet further includes a DC power supply circuit 7. The DC power supply circuit 7 includes MOSFET M5 and chip U1 in series, connected to the USB charging module 10 and main control unit 3, capacitor C9 connected between the IN and GND pins of chip U1, capacitor C17 connected between the OUT and GND pins of chip U1, capacitor C19 connected between the D and G pins of MOSFET M5, and capacitors C20 and C16 in parallel between the S and G pins of MOSFET M5. The source pin(S) of MOSFET M5 is connected to the IN pin of chip U1 and receives +12V, the drain pin (D) of MOSFET M5 is connected to the VCC pin of USB charging module 10, and the gate pin (G) of MOSFET M5 is connected to the HGND pin. The GND pin of chip U1 is connected to the HGND pin, and the OUT pin of chip U1 is connected to AC-5V. DC12V is used to power the driver chip in main control unit 3, and DC5V is used to power the main control chip in main control unit 3.

In one embodiment, the step-down pure sine wave voltage conversion outlet further includes an NTC temperature detection circuit 8 to detect the temperature of heating components, providing a basis for component over-temperature protection. The NTC temperature detection circuit 8 includes capacitors C14, C15 and resistors R15, R17, R18, where resistor R17 is the NTC temperature detection resistor connected to the AC-5V pin. Resistor R15, capacitor C14, and resistor R18 are connected in parallel at one end of resistor R17. Capacitor C15 is connected between capacitor C14, resistor R15, and resistor R18. One end of capacitor C15 is connected to the TFB pin of the main control chip, and the other end is connected to the HGND pin.

In one embodiment, the step-down pure sine wave voltage conversion outlet further includes a touch module 9. The touch module 9 controls the ON and OFF of main control unit 3 by outputting high and low levels. When the device is in the OFF state, a single touch on the touch switch causes the touch IC to output a high level to main control unit 3, and main control unit 3 generates a sine wave pulse width modulation (SPWM) signal to drive the inverter bridge circuit, thus causing the output AC socket to produce an AC voltage output; another touch on the touch switch causes the touch IC to output a low level to main control unit 3, main control unit 3 stops the sine wave pulse width modulation (SPWM) signal, the inverter bridge circuit stops operating, and the AC socket has no voltage output.

In one embodiment, the step-down pure sine wave voltage conversion outlet further includes a USB charging module 10. The USB charging module 10 includes fuse F3, power main control chip U2, transformer TI, power controller U6, synchronous buck converter U9, first USB unit 101, second USB unit 102, third USB unit 103, and fourth USB unit 104. Fuse F3 is connected to rectification and filtering module 2. The DC power supply circuit 7 is connected to the VCC pin of power main control chip U2. The first USB unit 101 and second USB unit 102 are TYPE-C output interfaces.

In one embodiment, the voltage and current feedback module 5 includes an output voltage detection module 51 connected to the output of energy storage and filtering module 6 and an output current detection module 52 connected to inverter bridge module 4. The output voltage detection module 51 includes resistors R38, R39, R40 in series on the L-OUT pin, and a resistor R41 and capacitor C25 in parallel across resistor R40. The other end of resistor R40, resistor R41, and capacitor C25 is connected to main control unit 3. The output current detection module 52 includes resistors R30, R31, R32, R27 in parallel on the source(S) pins of MOSFET M3 and MOSFET M4, along with capacitor C24 and resistor R25 in parallel with resistor R27.

The main control unit 3 also includes a fan control module 30. The fan control module 30 includes resistors R29, R35, R66, R67, optocoupler P2, MOSFET M6, and fan F2. Resistors R44 and R46 are in series on the FANCTR pin of the main control chip, with one end of resistor R46 connected to the HGND pin. Optocoupler P2B is connected in parallel across resistor R35. The drain pin (D) of MOSFET M6 and optocoupler P2A are respectively connected to both ends of fan F2. Resistor R66 is connected between the gate (G) of MOSFET M6 and optocoupler P2A, resistor R67 is connected between the gate (G) of MOSFET M6 and ground, and the source(S) of MOSFET M6 is grounded.

In summary, the working principle of the present invention is as follows:
When in operation, municipal AC power is input through the fuse and NTC surge protection of AC input module 1, then through the DB1 bridge rectifier, and filtered by capacitors C5, C6, and C30 to become a smooth DC voltage HV, which is sent to the full-bridge DC-AC inverter circuit composed of MOSFET M1, MOSFET M2, MOSFET M3, MOSFET M4, inductor L1, and capacitor C12;
Further, main control unit 3 generates a 20 kHz SPWM waveform to drive MOSFETs M1, M2, M3, and M4 in turn;
Further, MOSFETs M2, M3, and M4 form one set of switches. Under the 20kHz SPWM drive signal from main control unit 3, MOSFET M2 is switched on and off, MOSFET M3 remains continuously on, MOSFET M1 does not conduct, and when MOSFET M2 is off, MOSFET M4 provides a freewheeling path for inductor L1. The SPWM duty cycle increases in sequence from small to large until reaching the top of the sine wave, and then decreases from large to small. The HV DC passes from MOSFET M2 into the energy storage and filtering network formed by inductor L1 and capacitor C12. Inductor L1 and capacitor C12 convert the switching pulses from MOSFET M2 into the positive half of the sine wave;
Further, MOSFETs M1, M4, and M2 form the negative half of the sine wave. Under the 20 kHz SPWM drive waveform from main control unit 3, MOSFET M4 is switched on and off, MOSFET M3 does not operate, MOSFET M2 is turned on to provide a freewheeling path for inductor L1 when MOSFET M4 is off, and MOSFET M1 remains continuously on. The SPWM duty cycle again increases from small to large until reaching the top of the sine wave, then decreases from large to small. The HV DC passes from MOSFET M1 to the energy storage and filtering network formed by inductor L1 and capacitor C12, converting the pulses from MOSFET M1 into the negative half of the sine wave. During this process, inductor L1 and capacitor C12 form a filtering network to transform the SPWM pulses delivered by the switching MOSFETs into a sine wave;
Further, the filtering network composed of inductor L1 and capacitor C12 smooths the SPWM pulses into a sine wave, which is output from the L-OUT pin and N-OUT pin;
Further, the feedback loop composed of resistors R38, R39, R40, R41, capacitor C25 detects the output voltage size and transmits it to the main control chip. The main control chip adjusts the duty cycle based on the detected voltage, keeping the output voltage stable;
Further, the output current detection circuit composed of resistors R30, R31, R32, R27, capacitor C24 detects the size of the output current and any output short-circuits. If the output current is too large or a short-circuit happens, it stops the output in time to protect the circuit;
Further, chip U8 and its ancillary circuit form the touch switch circuit for controlling the working status of the main control chip, such as enabling or disabling the output;
Further, the fan control circuit composed of resistor R29, resistor R35, optocoupler P2, MOSFET M6, etc., allows main control chip to output a high level to drive optocoupler P2 to control fan F2 when the temperature is high;
Further, the temperature detection circuit composed of resistor R17, resistor R18, resistor R15, capacitor C14, etc., detects temperature. Resistor R17 is the NTC temperature detection resistor, whose value decreases with increasing temperature. When the main control chip detects high temperature, it outputs a high level to drive fan F2 for heat dissipation. If the temperature exceeds the rated limit, the circuit output is shut off to provide over-temperature protection;
Further, MOSFET M5 and chip U1 form the power supply circuit for IC1. The power is drawn from the VCC pin of power main control chip U2 in USB charging module 10, then stepped down to DC12V and DC5V, which respectively supply the control circuit and drive circuit of the main control chip.

In the above solution, the present invention adopts a method wherein the input AC voltage (110-250V) is directly rectified and filtered, and through adjusting the duty cycle in a circuit composed of MOSFET M1, MOSFET M2, MOSFET M3, MOSFET M4, inductor L1, and capacitor C12, outputs an AC voltage of 100-130V. There is no need to first step down the input 200-250V, then have MOSFET M1, MOSFET M2, MOSFET M3, MOSFET M4, inductor L1, and capacitor C12 produce the 100-130V AC output. A separate step-down circuit is eliminated, making the circuit simpler and reducing loss.

Additionally, the method to achieve this goal is not limited to the single-polarity modulation circuit described above, but also includes biphasic modulation circuits. For example, in biphasic modulation, two complementary transistors can be driven simultaneously by the SPWM waveform. When MOSFETs M2 and M3 are working, MOSFET M2 and MOSFET M3 can each be driven by a complementary 20 kHz SPWM switching waveform (instead of MOSFET M2 alone being driven by 20 kHz while MOSFET M3 is continuously on). Inductor L1 can be two inductors or a single magnetic core wound with two mutually coupled coils; the voltage detection circuit can also be duplicated.

Of course, the above is merely a specific embodiment of the present invention and does not limit its scope. Any equivalent changes or modifications made according to the structure, features, and principles described in the claims of the present invention should be included within the scope of the present invention.

I claim

1. A step-down socket integrated with a pure sine wave voltage conversion function, comprising:
an AC input module (1) configured to receive AC mains power and deliver AC mains power to a rectification and filtering module (2), which rectifies and filters the AC mains power into DC,
a main control unit (3), an inverter bridge module (4), and a voltage and current feedback module (5), wherein the main control unit (3) generates a sine wave pulse-width modulation (SPWM) signal to control the switching and duty cycle of the inverter bridge module (4), causing the inverter bridge module (4) to convert the DC from the rectification and filtering module (2) into a pulsed voltage and output the pulsed voltage to an energy storage and filtering module (6);
wherein the inverter bridge module (4) comprises a plurality of MOSFETs, whose input is connected to the rectification and filtering module (2), and whose output is connected to the energy storage and filtering module (6); the energy storage and filtering module (6) is connected to the inverter bridge module (4) for filtering the pulsed voltage into a pure sine wave AC voltage, which is then output through an AC terminal;
the voltage and current feedback module (5) is connected to the output end of the energy storage and filtering module (6) for detecting the output voltage and current, and for transmitting feedback signals to the main control unit (3); the main control unit (3) adjusts the SPWM signal according to the feedback voltage and current signals to stabilize the output sine wave voltage.

2. The step-down socket integrated with the pure sine wave voltage conversion function according to claim 1, wherein the inverter bridge module (4) comprises MOSFETs M1, M2, M3, and M4, each MOSFET's gate (G) being connected through a peripheral driver unit to a driver chip in the main control unit (3). When the main control chip of the main control unit (3) outputs a sine wave pulse-width modulation (SPWM) signal, the main control chip drives the four MOSFETs to operate, generating a pulse-width-modulated sine wave voltage waveform, which is filtered by the connected energy storage and filtering module (6) into a pure sine wave AC voltage output.

3. The step-down socket integrated with the pure sine wave voltage conversion function according to claim 1, wherein the energy storage and filtering module (6) comprises an inductor L1 and a capacitor C12, which are connected between the inverter bridge module (4) and the AC terminal to filter the pulse-width-modulated sine wave voltage generated by the inverter bridge module (4) into a pure sine wave AC voltage output.

4. The step-down socket integrated with the pure sine wave voltage conversion function according to claim 2, further comprising a DC power supply circuit (7), wherein the DC power supply circuit (7) includes DC12V and DC5V, with DC12V supplying power to the driver chip in the main control unit (3), and DC5V supplying power to the main control chip in the main control unit (3).

5. The step-down socket integrated with the pure sine wave voltage conversion function according to claim 1, further comprising an NTC temperature detection circuit (8), which detects the temperature of heating components and provides a basis for over-temperature protection of the components.

6. The step-down socket integrated with the pure sine wave voltage conversion function according to claim 1, further comprising a touch module (9); the touch module (9) controls the ON/OFF state of the main control unit (3) by outputting high/low signals; when the device is off, a single touch on the touch switch causes the touch IC to output a high signal to the main control unit (3), prompting the main control unit (3) to generate a sine wave pulse-width modulation (SPWM) signal that drives the inverter bridge circuit, thereby producing an AC voltage output at the AC outlet; upon another touch of the touch switch, the touch IC outputs a low signal to the main control unit (3), and the main control unit (3) stops the SPWM signal, causing the inverter bridge circuit to cease operation and the AC outlet to have no output voltage.

7. The step-down socket integrated with the pure sine wave voltage conversion function according to claim 1, further comprising a USB charging module (10).
